(19) United States
(12) Patent Application Publication
(10) Pub. No.: US 2022/0067630 A1
(43) Pub. Date: Mar. 3, 2022

(54) SYSTEMS AND METHODS RELATED TO PREDICTING AND PREVENTING HIGH RATES OF AGENT ATTRITION IN CONTACT CENTERS

(71) Applicant: Genesys Telecommunications Laboratories, Inc., Daly City, CA (US)

(72) Inventors: Anantha Krishnan Asokan, Hyderabad (IN); Balaji Gokulakannan, Chennai (IN); Vidhyasimhan Jayaraghavendran, Chennai (IN)

(73) Assignee: Genesys Telecommunications Laboratories, Inc., Daly City, CA (US)

(21) Appl. No.: 17/465,119

(22) Filed: Sep. 2, 2021

Related U.S. Application Data
(60) Provisional application No. 63/074,035, filed on Sep. 3, 2020.

(51) Int. Cl. G06Q 10/06; H04M 3/51; G06F 40/40; G06N 20/00

(52) U.S. Cl. CPC G06Q 10/06398; H04M 3/5175; H04M 2203/402; G06N 20/00; H04M 2203/401; G06F 40/40

(57) ABSTRACT

A method related to predicting agent attrition rate that includes: providing an attrition model; measuring and recording agent journey data of a first agent of a contact center, the agent journey data describing aspects related to an employment of the first agent and having data types that corresponds in kind to data types of inputs of the attrition model; determining that prediction of an attrition rate of the first agent is required; using the attrition model to predict the attrition rate by providing values for the inputs from applicable values taken from the agent journey data of the first agent, and calculating the attrition rate as the output of the attrition model; determining if the calculated current attrition rate indicates a high risk of attrition; and transmitting an alert communication to a supervisor of the first agent.

### CROSS REFERENCE TO RELATED APPLICATION

This application claims the benefit of U.S. Provisional Patent Application No. 63/074,035, titled “SYSTEMS AND METHODS RELATING TO PREDICTING AND PREVENTING HIGH RATES OF AGENT ATTRITION IN CONTACT CENTERS”, filed in the U.S. Patent and Trademark Office on Sep. 3, 2020, the contents of which are incorporated herein.

### BACKGROUND

The present invention generally relates to telecommunications systems in the field of customer relations management including customer assistance via call or contact centers and internet-based service options. More particularly, but not by way of limitation, the present invention pertains to systems and methods for automating aspects of contact center operations and customer experience, including customer services offered through an application executed on a mobile computing device that offer post-purchase support to customers. The present invention further relates to predicting agent attrition in contact centers.

### BRIEF DESCRIPTION OF THE INVENTION

The present invention includes a computer-implemented method related to predicting an attrition rate for agents employed at a contact center. The method may include the steps of: providing an attrition model that is a machine learning model trained pursuant to a training dataset of corresponding inputs and outputs and where the training of the attrition model includes learning patterns in the inputs that indicate a value for the output, the inputs including one or more data types of agent employment data, one or more data types of agent interaction data, and one or more data types of agent adherence data, and the output including an attrition rate for an agent; measuring and recording agent journey data of a first agent currently employed at the contact center, wherein the agent journey data describes aspects related to an employment of the first agent at the contact center and comprises data types that corresponds in kind to the data types of the inputs of the attrition model; determining that a prediction of a current attrition rate of the first agent is required; using the attrition model to predict the current attrition rate of the first agent by providing values for the inputs to the attrition model from applicable current values taken from the corresponding data types of the agent journey data of the first agent, and given the provided inputs, calculating the current attrition rate of the first agent as the output of the attrition model; determining if the calculated current attrition rate of the first agent satisfies a threshold attrition rate, wherein satisfying the threshold attrition rate indicates that the first agent has a high risk of attrition; and in response to determining that the first agent has a high risk of attrition, automatically generating and transmitting an alert communication to a computing device associated with a second employee of the contact center that informs the second employee that the first agent has the high risk of attrition.

These and other features of the present application will become more apparent upon review of the following detailed description of the example embodiments when taken in conjunction with the drawings and the appended claims.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIG. 3 is a schematic representation of an exemplary agent attrition module in accordance with exemplary embodiments of the present invention;

FIG. 4 is an agent journey visualization in accordance with exemplary embodiments of the present invention; and

FIG. 5 is a method for providing agent attrition predictions in accordance with exemplary embodiments of the present invention.

### DETAILED DESCRIPTION

For the purposes of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail in order to avoid obscuring the present invention. Additionally, further modification in the provided examples or application of the principles of the invention, as presented herein, are contemplated as would normally occur to those skilled in the art.

As used herein, language designating nonlimiting examples and illustrations includes “e.g.”, “i.e.”, “for example”, “for instance” and the like. Further, reference throughout this specification to “an embodiment”, “one embodiment”, “present embodiments”, “exemplary embodiments”, “certain embodiments” and the like means that a particular feature, structure or characteristic described in connection with the given example may be included in at least one embodiment of the present invention. Thus, appearances of the phrases “an embodiment”, “one embodiment”, “present embodiments”, “exemplary embodiments”, “certain embodiments” and the like are not necessarily referring to the same embodiment or example. Further, particular features, structures or characteristics may be combined in any suitable combinations and/or sub-combinations in one or more embodiments or examples.

Those skilled in the art will recognize from the present disclosure that the various embodiments may be computer implemented using many different types of data processing equipment, with embodiments being implemented as an apparatus, method, or computer program product. Example embodiments, thus, may take the form of an entirely hardware embodiment, an entirely software embodiment, or an embodiment combining software and hardware aspects. Example embodiments further may take the form of a computer program product embodied by computer-usable program code in any tangible medium of expression. In each case, the example embodiment may be generally referred to as a “module”, “system”, or “method”.

The flowcharts and block diagrams provided in the figures illustrate architecture, functionality, and operation of possible implementations of systems, methods, and computer program products in accordance with example embodiments of the present invention. In this regard, it will be understood that each block of the flowcharts and/or block diagrams—or combinations of those blocks—may represent a module, segment, or portion of program code having one or more executable instructions for implementing the specified logical functions. It will similarly be understood that each of block of the flowcharts and/or block diagrams—or combinations of those blocks—may be implemented by special purpose hardware-based systems or combinations of special purpose hardware and computer instructions performing the specified acts or functions. Such computer program instructions also may be stored in a computer-readable medium that can direct a computer or other programmable data processing apparatus to function in a particular manner, such that the program instructions in the computer-readable medium produces an article of manufacture that includes instructions by which the functions or acts specified in each block of the flowcharts and/or block diagrams—or combinations of those blocks—are implemented.

### Computing Device

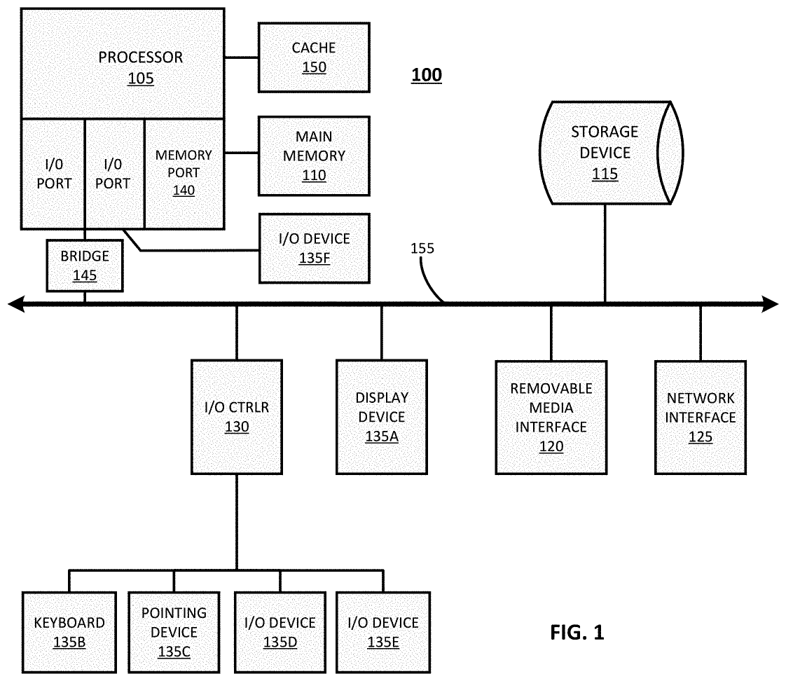

It will be appreciated that the systems and methods of the present invention may be computer implemented using many different forms of data processing equipment, for example, digital microprocessors and associated memory, executing appropriate software programs. By way of background, FIG. 1 illustrates a schematic block diagram of an exemplary computing device 100 in accordance with embodiments of the present invention and/or with which those embodiments may be enabled or practiced. It should be understood that FIG. 1 is provided as a non-limiting example.

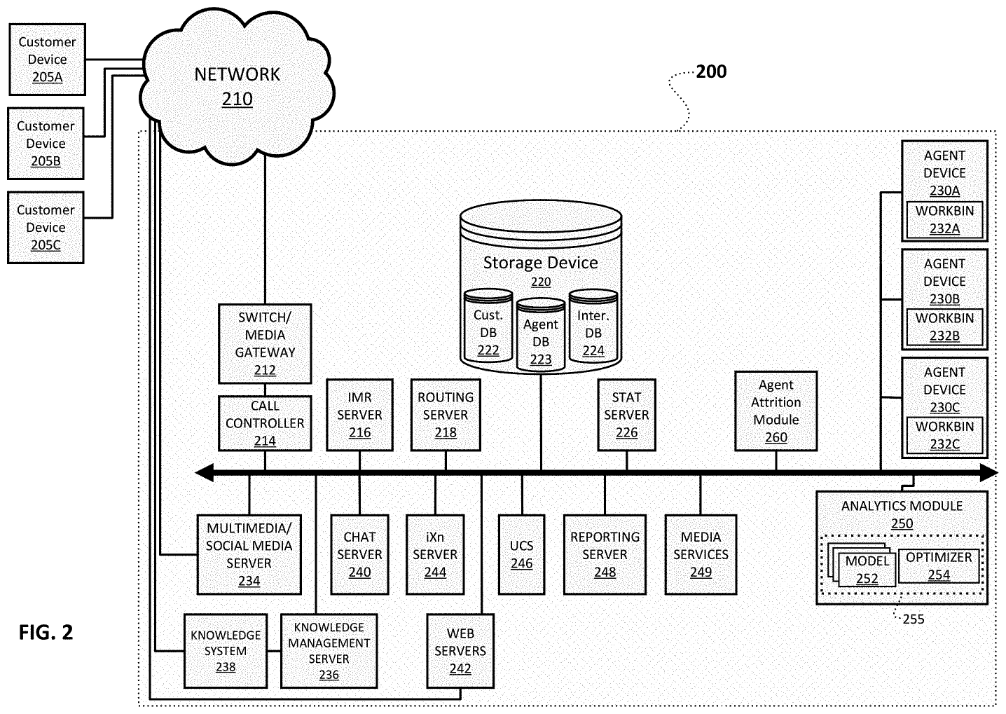

The computing device 100, for example, may be implemented via firmware (e.g., an application-specific integrated circuit), hardware, or a combination of software, firmware, and hardware. It will be appreciated that each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures—such as, for example, the contact center system 200 of FIG. 2—the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (SaaS) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to and processes instructions fetched from the main memory 110. For example, the process 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The cache memory 150 typically has a faster response time than main memory 110. The main memory 110 may be one or more memory chips capable of storing data and allowing stored data to be directly accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. The I/O devices 135 and/or the I/O controller 130 may include suitable hardware and/or software for enabling the use of multiple display devices. The computing device 100 may also support one or more removable media interfaces 120, such as a disk drive, USB port, or any other device suitable for reading data from or writing data to computer readable media. More generally, the I/O devices 135 may include any conventional devices for performing the functionality described herein.

The computing device 100 may be any workstation, desktop computer, laptop or notebook computer, server machine, virtualized machine, mobile or smart phone, portable telecommunication device, media playing device, gaming system, mobile computing device, or any other type of computing, telecommunications or media device, without limitation, capable of performing the operations and functionality described herein.

### Contact Center

With reference now to FIG. 2, a communications infrastructure or contact center system 200 is shown in accordance with exemplary embodiments of the present invention and/or with which exemplary embodiments of the present invention may be enabled or practiced. It should be understood that the term “contact center system” is used herein to refer to the system depicted in FIG. 2 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 200), the associated customer service provider (such as a particular customer service provider providing customer services through the contact center system 200), as well as the organization or enterprise on behalf of which those customer services are being provided.

By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots”, automated chat modules or “chatbots”, and the like. In many cases this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

Referring specifically to FIG. 2, the contact center system 200 may be used by a customer service provider to provide various types of services to customers. For example, the contact center system 200 may be used to engage and manage interactions in which automated processes (or bots) or human agents communicate with customers. As should be understood, the contact center system 200 may be an in-house facility to a business or enterprise for performing the functions of sales and customer service relative to products and services available through the enterprise. In another aspect, the contact center system 200 may be operated by a third-party service provider that contracts to provide services for another organization. Further, the contact center system 200 may be deployed on equipment dedicated to the enterprise or third-party service provider, and/or deployed in a remote computing environment such as, for example, a private or public cloud environment with infrastructure for supporting multiple contact centers for multiple enterprises. The contact center system 200 may include software applications or programs, which may be executed on premises or remotely or some combination thereof. It should further be appreciated that the various components of the contact center system 200 may be distributed across various geographic locations and not necessarily contained in a single location or computing environment.

It should further be understood that, unless otherwise specifically limited, any of the computing elements of the present invention may be implemented in cloud-based or cloud computing environments. As used herein, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center system 200 may include: a plurality of customer devices 205A, 205B, 205C; communications network (or simply “network”) 210; switch/media gateway 212; call controller 214; interactive media response (IMR) server 216; routing server 218; storage device 220; statistics (or “stat”) server 226; plurality of agent devices 230A, 230B, 230C that include workbins 232A, 232B, 232C, respectively; multimedia/social media server 234; knowledge management server 236 coupled to a knowledge system 238; chat server 240; web servers 242; interaction (or “iXn”) server 244; universal contact server (or “UCS”) 246; reporting server 248; media services server 249; an analytics module 250; and an agent attrition server or module (“agent attrition module”) 260. It should be understood that any of the computer-implemented components, modules, or servers described in relation to FIG. 2 or in any of the following figures may be implemented via types of computing devices, such as, for example, the computing device 100 of FIG. 1. As will be seen, the contact center system 200 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and the like.

Customers desiring to receive services from the contact center system 200 may initiate inbound communications (e.g., telephone calls, emails, chats, etc.) to the contact center system 200 via a customer device 205. While FIG. 2 shows three such customer devices—i.e., customer devices 205A, 205B, and 205C—it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center system 200, such as telephone calls, emails, chats, text messages, web-browsing sessions, and other multi-media transactions.

Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN such as the Internet.

In regard to the switch/media gateway 212, it may be coupled to the network 210 for receiving and transmitting telephone calls between customers and the contact center system 200. The switch/media gateway 212 may include a telephone or communication switch configured to function as a central switch for agent level routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. Thus, in general, the switch/media gateway 212 establishes a voice connection between the customer and the agent by establishing a connection between the customer device 205 and agent device 230.

As further shown, the switch/media gateway 212 may be coupled to the call controller 214 which, for example, serves as an adapter or interface between the switch and the other routing, monitoring, and communication-handling components of the contact center system 200. The call controller 214 may be configured to process PSTN calls, VoIP calls, etc. For example, the call controller 214 may include computer-telephone integration (CTI) software for interfacing with the switch/media gateway and other components. The call controller 214 may include a session initiation protocol (SIP) server for processing SIP calls. The call controller 214 may also extract data about an incoming interaction, such as the customer's telephone number, IP address, or email address, and then communicate these with other contact center components in processing the interaction.

In regard to the interactive media response (IMR) server 216, it may be configured to enable self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. For example, a contact center for a bank may tell customers via the IMR script to “press 1” if they wish to retrieve their account balance. Through continued interaction with the IMR server 216, customers may receive service without needing to speak with an agent. The IMR server 216 may also be configured to ascertain why a customer is contacting the contact center so that the communication may be routed to the appropriate resource.

In regard to the routing server 218, it may function to route incoming interactions. For example, once it is determined that an inbound communication should be handled by a human agent, functionality within the routing server 218 may select the most appropriate agent and route the communication thereto. This agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230. This information is intended to enhance the service the agent is able to provide to the customer.

Regarding data storage, the contact center system 200 may include one or more mass storage devices—represented generally by the storage device 220—for storing data in one or more databases relevant to the functioning of the contact center. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center system 200 may include agent availability and agent profiles, schedules, skills, handle time, etc. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center system 200 in ways that facilitate the functionality described herein. For example, the servers or modules of the contact center system 200 may query such databases to retrieve data stored therewithin or transmit data thereto for storage. The storage device 220, for example, may take the form of any conventional storage medium and may be locally housed or operated from a remote location.

In regard to the stat server 226, it may be configured to record and aggregate data relating to the performance and operational aspects of the contact center system 200. Such information may be compiled by the stat server 226 and made available to other servers and modules, such as the reporting server 248, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center system 200 in ways that facilitate functionality described herein. An agent device 230, for example, may include a telephone adapted for regular telephone calls or VoIP calls. An agent device 230 may further include a computing device configured to communicate with the servers of the contact center system 200, perform data processing associated with operations, and interface with customers via voice, chat, email, and other multimedia communication mechanisms according to functionality described herein. While FIG. 2 shows three such agent devices—i.e., agent devices 230A, 230B and 230C—it should be understood that any number may be present.

In regard to the multimedia/social media server 234, it may be configured to facilitate media interactions (other than voice) with the customer devices 205 and/or the servers 242. Such media interactions may be related, for example, to email, voice mail, chat, video, text-messaging, web, social media, co-browsing, etc. The multi-media/social media server 234 may take the form of any IP router conventional in the art with specialized hardware and software for receiving, processing, and forwarding multi-media events and communications.

In regard to the knowledge management server 234, it may be configured facilitate interactions between customers and the knowledge system 238. In general, the knowledge system 238 may be a computer system capable of receiving questions or queries and providing answers in response. The knowledge system 238 may be included as part of the contact center system 200 or operated remotely by a third party. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials, as is known in the art. As an example, the knowledge system 238 may be embodied as IBM Watson or a like system.

In regard to the chat server 240, it may be configured to conduct, orchestrate, and manage electronic chat communications with customers. In general, the chat server 240 is configured to implement and maintain chat conversations and generate chat transcripts. Such chat communications may be conducted by the chat server 240 in such a way that a customer communicates with automated chatbots, human agents, or both. In exemplary embodiments, the chat server 240 may perform as a chat orchestration server that dispatches chat conversations among the chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature, including those UIs generated at either the customer device 205 or the agent device 230. The chat server 240 may be configured to transfer chats within a single chat session with a particular customer between automated and human sources such that, for example, a chat session transfers from a chatbot to a human agent or from a human agent to a chatbot. The chat server 240 may also be coupled to the knowledge management server 234 and the knowledge systems 238 for receiving suggestions and answers to queries posed by customers during a chat so that, for example, links to relevant articles can be provided.

In regard to the web servers 242, such servers may be included to provide site hosts for a variety of social interaction sites to which customers subscribe, such as Facebook, Twitter, Instagram, etc. Though depicted as part of the contact center system 200, it should be understood that the web servers 242 may be provided by third parties and/or maintained remotely. The web servers 242 may also provide webpages for the enterprise or organization being supported by the contact center system 200. For example, customers may browse the webpages and receive information about the products and services of a particular enterprise. Within such enterprise webpages, mechanisms may be provided for initiating an interaction with the contact center system 200, for example, via web chat, voice, or email. An example of such a mechanism is a widget, which can be deployed on the webpages or websites hosted on the web servers 242. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

In regard to the interaction (iXn) server 244, it may be configured to manage deferrable activities of the contact center and the routing thereof to human agents for completion. As used herein, deferrable activities include back-office work that can be performed off-line, e.g., responding to emails, attending training, and other activities that do not entail real-time communication with a customer. As an example, the interaction (iXn) server 244 may be configured to interact with the routing server 218 for selecting an appropriate agent to handle each of the deferable activities. Once assigned to a particular agent, the deferable activity is pushed to that agent so that it appears on the agent device 230 of the selected agent. The deferable activity may appear in a workbin 232 as a task for the selected agent to complete. The functionality of the workbin 232 may be implemented via any conventional data structure, such as, for example, a linked list, array, etc. Each of the agent devices 230 may include a workbin 232, with the workbins 232A, 232B, and 232C being maintained in the agent devices 230A, 230B, and 230C, respectively. As an example, a workbin 232 may be maintained in the buffer memory of the corresponding agent device 230.

In regard to the universal contact server (UCS) 246, it may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer such as, for example, data related to comments from agents, customer communication history, and the like. Each of these data types then may be stored in the customer database 222 or on other modules and retrieved as functionality described herein requires.

In regard to the reporting server 248, it may be configured to generate reports from data compiled and aggregated by the statistics server 226 or other sources. Such reports may include near real-time reports or historical reports and concern the state of contact center resources and performance characteristics, such as, for example, average wait time, abandonment rate, agent occupancy. The reports may be generated automatically or in response to specific requests from a requestor (e.g., agent, administrator, contact center application, etc.). The reports then may be used toward managing the contact center operations in accordance with functionality described herein.

In regard to the media services server 249, it may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and the like.

In regard to the analytics module 250, it may be configured to provide systems and methods for performing analytics on data received from a plurality of different data sources as functionality described herein may require. In accordance with example embodiments, the analytics module 250 also may generate, update, train, and modify predictors or models 252 based on collected data, such as, for example, customer data, agent data, and interaction data. The models 252 may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module 250 is depicted as being part of a contact center, such behavior models also may be implemented on customer systems (or, as also used herein, on the “customer-side” of the interaction) and used for the benefit of customers.

According to exemplary embodiments, the analytics module 250 may have access to the data stored in the storage device 220, including the customer database 222 and agent database 223. The analytics module 250 also may have access to the interaction database 224, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, as discussed more below, the analytic module 250 may be configured to retrieve data stored within the storage device 220 for use in developing and training algorithms and models 252, for example, by applying machine learning techniques.

One or more of the included models 252 may be configured to predict customer or agent behavior and/or aspects related to contact center operation and performance. Further, one or more of the models 252 may be used in natural language processing and, for example, include intent recognition and the like. The models 252 may be developed based upon 1) known first principle equations describing a system, 2) data, resulting in an empirical model, or 3) a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, it may be preferable that the models 252 are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach is presently a preferred embodiment for implementing the models 252. Neural networks, for example, may be developed based upon empirical data using advanced regression algorithms.

The analytics module 250 may further include an optimizer 254. As will be appreciated, an optimizer may be used to minimize a “cost function” subject to a set of constraints, where the cost function is a mathematical representation of desired objectives or system operation. Because the models 252 may be non-linear, the optimizer 254 may be a nonlinear programming optimizer. It is contemplated, however, that the present invention may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to exemplary embodiments, the models 252 and the optimizer 254 may together be used within an optimization system 255. For example, the analytics module 250 may utilize the optimization system 255 as part of an optimization process by which aspects of contact center performance and operation are optimized or, at least, enhanced. This, for example, may include aspects related to the customer experience, agent experience, interaction routing, natural language processing, intent recognition, or other functionality related to automated processes.

In regard to the agent attrition module 260, this module may provide services for predicting and preventing agent attrition. As discussed in more detail below, the agent attrition module 260 accomplishes this by first maintaining and compiling an agent journey map for each agent which compiles career milestones, performance characteristics, anomalies, and other data representative of an agent's employment with a contact center. This data is then be analyzed via an agent attrition predictor so to make a prediction about when an agent may leave their employment with a contact center.

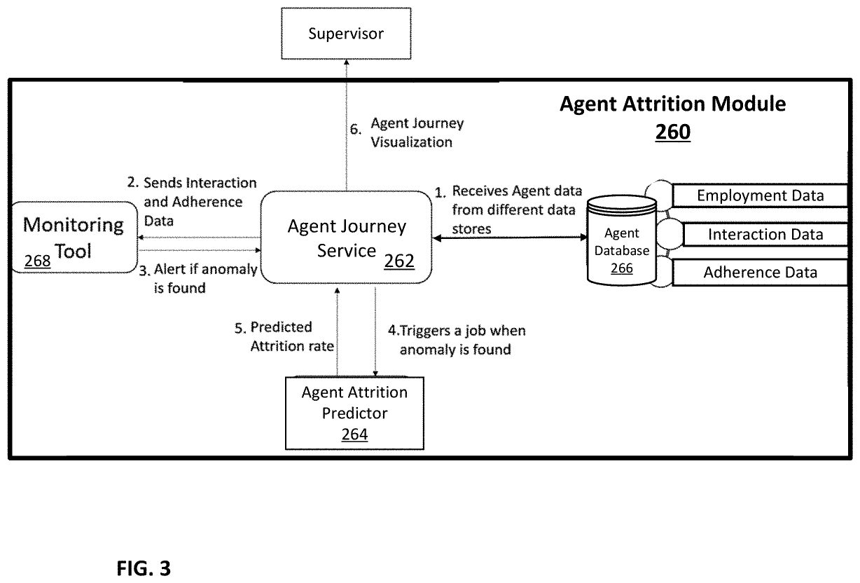

With reference now to FIGS. 3-5, methods and systems related to predicting agent attrition in contact centers will be discussed. By way of background, contact centers regularly lose agents and are constantly tasked with hiring replacements to maintain sufficient numbers. In fact, most managers or supervisors of contact centers believe that overcoming high agent turnover rates is their primary challenge. The statistics bear this out, as contact centers generally have an average annual agent attrition rate of 30% to 45%. This high turnover rate is very costly, as the process of hiring and training agents is expensive. Additionally, even after training, new agents take time before reaching effective performance levels, which further impacts the level of customer service a contact center is able to provide.

The reasons for this high turnover rate are many. A few of these include emotional disconnect from the workplace and culture, negative relationships with supervisors and coworkers, agents not being recognized for good work, no growth potential, and agents feeling undervalued. However, given the large number of agents in contact centers, it is almost impossible for supervisors to monitor each agent closely for signs the unhappiness. What is needed is a process for identifying the gaps that develop between agents and contact centers that often are the source of discontentment and a reason for high attrition rates.

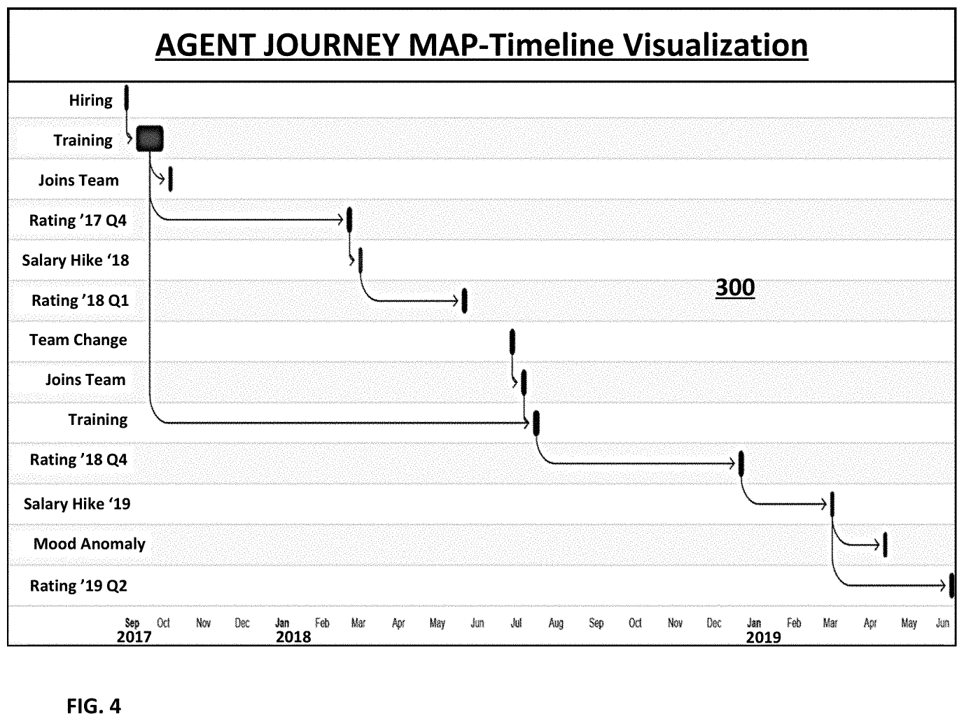

With reference to FIG. 3, the present disclosure proposes methods and systems for predicting agent attrition, including, for example, an agent attrition module 260. The agent attrition module 260, which is represented schematically in FIG. 3, may include a several components, including an agent journey application or service (hereafter “agent journey service”) 262, an agent attrition predictor 264, an agent database 266, and a monitoring tool 268. The agent attrition module 260 accomplishes such attrition predictions by first maintaining and compiling, within the agent journey service 262, an agent journey map for each agent. The agent journey map is a detailed representation of an agent's employment at a contact center. As will be seen, the agent journey map created for each agent compiles career milestones, performance characteristics, and other data that is reflective of the agent's work with the contact center. This data then is analyzed via the agent attrition predictor 264 so to predict an individualized attrition probability for an agent. As will be seen, when a particular attrition probability threshold is satisfied (which indicates a high risk of attrition for a given agent), the agent attrition module 260 may include functionality that alerts a manager or supervisor so that corrective action can be taken that decreases the likelihood of an agent leaving their employment. The agent journey service 262 may include functionality that creates an agent journey visualization 300, which is shown in FIG. 4. As will be discussed more below, the agent journey visualization 300 is a timeline that efficiently communicates the employment record of the agent and performance anomalies, for example, performance anomalies that triggered an attrition alert to a supervisor.

The agent journey map maintained in regard to an agent connects the important dots across an agent's work or employment with a contact center. The agent journey map is derived from a store of data related to an agent's employment. This store of data may be referred to as agent journey data. The agent journey visualization can be thought of as a visualization tool for understanding the agent journey data underlying an agent's employment. The agent journey visualization may be used to alert a supervisor as to an increased risk of a given agent leaving their employment at the contact center while, at the same time, efficiently presenting a summary of the agent's employment. Selected portions of the agent journey data may then function as an input to the agent attrition predictor for performing predictive analysis. As will be seen, this analysis may be performed in the background, with alerts being sent to supervisors when particular high attrition risks are identified. Alternatively, one or more factors or anomalies may be identified that trigger the predictive analysis as to attrition. In certain cases, when an alert is sent out regarding a high attritional risk to a subject agent, the anomalies that triggered the predictive analysis are also communicated to the supervisor (for example, in an agent journey visualization provided to the supervisor as part of the alert), as the nature of the anomalies often provide guidance to the supervisor as to what type of corrective action may be successful in lowering the risk of losing the subject agent.

As discussed above in regard the functioning of an exemplary contact center (i.e., the contact center 200), such operations collect many types of data during the course of normal operation. This data includes many types of information describing aspects of an agent's career, employment, and performance at the contact center. Generally, though, in convention systems, this data is scattered and distributed in different databases, and contact centers fail to properly aggregate and analyze this data and, thus, miss opportunities to see the underlying patterns that can be used to predict agent attrition. The agent journey map compiled by the agent journey service 262 of the present invention brings together available agent data, adds certain data components to it, and determines combinations of data that is highly predictive in relation to agent attrition. In this way, a clearer picture emerges as to the current status of an agent's employment with a contact center. As will be seen, the greater clarity can be used to make predictions about agent attrition.

In accordance with exemplary embodiments, an agent database 264 stores agent data that is used by the agent journey service 262 to create and maintain an agent journey map and corresponding agent journey data for a given agent. The types of agent data stored for these purposes can be categorized into the following categories: agent employment data, agent interaction data, and agent adherence data. Each of these data categories will now be discussed in more detail.

In regard to agent employment data, it will be appreciated that contact centers regularly collect and maintain employment data for agents in an agent database system that includes multiple data types. The agent attrition module 260 may connect with such databases and periodically collect predefined types of information or data types to build and maintain aspects of the agent journey map and agent journey data. The agent employment data used by the agent attrition module 260 to construct one of the agent journey maps may include what will be referred to herein as static and dynamic data types of employment data. In regard to static employment data, this type of data includes employment information that rarely or never changes. In accordance with exemplary embodiments, the data types collected in regard to static employment data may include: hiring date, gender, previous work experience in years, number of companies previously worked at, number of years at each company previously worked at, marital status, home address, distance of commute to work location, education level and area of study, exit date, and exit reason. As the name suggests, dynamic employment data includes data types that regularly change or at least change more often that the types listed above. This type of data changes periodically, for example, monthly, quarterly, half-yearly, etc. For example, the salary increases over the past 3 years has various data values across the years. In accordance with exemplary embodiments, the data types collected in regard to dynamic employment data may include: monthly income, changes in work department and dates related thereto, awards and recognitions received and dates related thereto, salary increases (e.g., in percentage) and dates related thereto, bonuses received and dates related thereto, promotions received and dates related thereto, over-time pay received and dates related thereto, number of years with current manager, amount of time in same role, information related to skill certifications or ratings, training received or training classes attended and dates related thereto, age, work travel and dates related thereto, changes in employment status (i.e., full-time or part-time and dates related thereto). Of course, the above employment data is subject to availability and, if not available, the agent attrition module 260 may derive the data from the data that is available.

In regard to agent interaction data, this category of data concerns data regarding an agent's behavior and actions within the context of interactions with customers. This data includes contact center-based agent conversations, performance, customer surveys and feedback, and behavioral information gleamed from interactions, i.e., interactions with customers, which may include voice, phone, video conferencing, text messaging, chat, email, etc. Such agent interaction data reveals much about how an agent behaved during interactions in the past and how that behavior has been changed, which has been found to correlate with agent attrition. According to exemplary embodiments, agent interaction data may include: handled interactions per given time period, type communication channel used for interactions, first contact resolutions, interactions left unanswered per given time period (i.e., interactions in which the agent was alerted of an incoming interaction but failed to respond), accepted interactions per given time period, amount of time customers spent on hold during interactions, percentage of interactions in which customer placed on hold, interaction handle time (i.e., the amount of time taken to handle an interaction including active conversation, holds, after work, etc.), frequency of interactions being transferred to another contact center resource (for example, transfers to another agent or manager or chatbot), frequency of during interaction consults (for example, consults with another agent or manager taking place during an interaction), frequency of blind consult interactions, time spent in after-interaction work (i.e., time taken to complete work required after the conversation with the customer has ended and/or time before the agent can accept another interaction), frequency of silence during interactions (i.e., how much of the conversational part of an interaction consisted of silence), frequency of talk-over instances in interactions (i.e., the number of times in an interaction when the agent and customer talked over each other), rating of customer sentiment for interactions (which may include an automated score that rates the customer sentiment for an interaction based on natural language analysis of customer statements during the interaction), customer feedback scores (i.e., satisfaction ratings provided by customers after interactions end), frequency of successful outcomes for interactions, and frequency of sales made. All the above interaction data may be collected and scored in a variety of way, include aggregate, mean, average, min, max, weighted, summed, totaled, frequency, percentage, etc. Such scores also may be collected and aggregated over various time periods, such as over the course of a shift, hour, week, month, year, etc. Such data may then be monitored over successive periods for changes or trends. As will be appreciated, the scores for each such data type can provide useful insights as to a particular agent's performance and how that performance changes over the course of day or month or year.

In regard to agent adherence data, this category of data refers to information related to how closely an agent adheres to or is in compliance with the policies and procedures associated with their employment at the contact center. According to exemplary embodiments, the data types collected and maintained for this category may include: frequency of breaks taken by an agent during shift and/or whether the frequency exceeds an allowed limit; duration of the breaks taken by the agent and/or whether the duration exceeds an allowed limit; frequency of coaching time; attendance record; hours worked per day; frequency of policy or adherence infractions; adherence score (indicating how close the agent adhered to policies over some given time period). As will be appreciated, the above data may be compiled and scored in a variety of different ways. As will further be appreciated, this type of data can provide insights to an agent's conscientious toward their employment, which has been found to be a key indicator as to the agent's employment satisfaction. For example, if an agent takes more breaks than usual or reduces their hours worked per day for unknown issues and violation of known policies, the agent journey map will track this development as a negative trend and as an anomaly, which will inform the attrition prediction for that agent.

In accordance with example embodiments, as part of an agent journey map, a personality model is created that models the personality of the agent. The personality model may be primarily based on the behavior of the agent exhibits when conducting interactions with customers. An agent's behavior during interactions may be monitored early in the agent's employment so that baseline personality of the agent is determined, which can then be compared against later behavior. The personality model may be created in the following way. First, content of the interactions relating to an agent, i.e., what the agent says, the words the agent uses, and intended meaning, may be analyzed. This analysis may include, for example, voice to text transcription of the interaction followed by natural language processing, intent analysis, key word searching, and other language processing technology. Along with content, the agent's voice may be monitored for sound characteristics indicative of emotional states, such as cheerfulness, anger, or stress, or sadness. Also, performance characteristics from the interactions may be monitored, such as, characteristics indicative of whether the interaction had a successful resolution, such as the resolution of a customer issue, the making of a sale, customer survey ratings, etc. A baseline agent personality model may be developed for each agent and then changes in behavior may be tracked against this baseline.

More specifically, according to exemplary embodiments, the agent personality model tracks changes over time to the agent's personality, mood, and behavior during interactions. Instead of just crudely rating an interaction as having been “good” or “bad” for an agent, the agent personality model may be constructed around a mood level evaluation that scores an agent's mood level during interactions. This may include rating an agent along several characteristics during an interaction and scoring the agent as to performance along a spectrum of unsatisfactory to satisfactory and then tracking how an average score for a given agent in each category changes over time. Such mood categories, for example, may include a positivity score, an empathy score, a patience score, an attentiveness score, etc. Once a baseline has been established, the agent's mood during interactions may continue to be monitored to determine if a drop in mood is severe enough to qualify as an anomaly. For example, if it is noticed that the agent is demonstrating a significant reduction in positivity and/or increase in anger, stress, or negativity over a prolonged period, the agent journey map may determine that the change in behavior constitutes an anomaly. As discussed more below, the monitoring tool 268 may be provided to track changes and identify such anomalies based on how much of a change is exhibited and for how long the change persists.

With an anomalous drop in performance and/or mood recorded for a given agent via the monitoring tool 268, the next step taken by the agent attrition module 260 may be to trigger the agent attrition predictor 264 to make an attrition prediction for the agent. As part of this, a likely cause of the anomaly and/or likely attrition outcome may be provided. The agent attrition predictor 264 may include an attrition model, which, according to preferred embodiments, is configured as a model, such as a machine learning model, that is trained from past agent journey data, for example including employment data, interaction data, adherence data and relatively changes thereto over time that correspond to given agents with known attritional outcomes. This is done to recognize certain patterns that indicate the likelihood of an agent staying or leaving the contact center, which can then be applied to currently employed agents. The attrition model may be constructed using several inputs found to have predictive relevance. These inputs may include the previously discussed mood level rating as well as any of the other of the data types discussed herein. For, example, the agent attritional model may include call transfers frequency, hold frequency, break time frequency, etc. Career milestones are also tracked as inputs, including time employed, training provided to the agent, amount of previous experience, time accrued since last promotion, time accrued since last salary raise, time accrued under current manager, and amount of overtime hours, etc. The model is trained pursuant to these inputs and known previous agent outputs, i.e., known agent attrition outcomes.

Once the agent attrition model is trained and the inputs to the model are determined, an attrition prediction for a subject agent may be performed. To do this, the values for the input data for the subject agent may be gathered from the data collected and maintained within the agent journey service 262 and/or the agent database 266. The gather data then may be provided as inputs into the attrition model and an attrition prediction related to the agent is calculated. The attrition prediction may be given as an attrition probability (e.g., the likelihood of losing that agent due to attrition within a given timeframe) or may be given as a prediction as to how much longer the agent will stay employed at the contact center.

This prediction may be performed for a particular agent based on an anomaly identified by the monitoring tool 268 within the agent journey map, which, for example, may be based on recent behavior or mood data that is identified as being anomalous given a baseline of behavior or mood for that agent. Supervisors also may be notified when such an anomaly is identified and asked as to whether the agent attrition predictor 264 should be used to provide an attrition prediction for the corresponding agent. Alternatively, the agent attrition prediction model may be run in the background for many agents at the same time or periodically and updated per new data from newly handled interactions and as other data regarding the agents becomes available. In such cases, the process may run in the background with supervisors only being notified when predictions for particular agents exceed a threshold indicative of a high attritional risks. As stated, such attrition prediction may be based on the set of data inputs selected from the agent journey data maintained via the agent journey service 262 and/or the agent database 264.

Wither reference to FIG. 4, an example is shown of an agent journey visualization 300 related to an agent journey map in accordance with the present invention. The agent journey map, as discussed, may be created and maintained for agents in the contact center. The agent journey visualization 300 may be provided in conjunction with the agent journey map so that information within the agent journey map can be visually communicated in an efficient way. As an example, the agent journey visualization 300 may be used as a supervisor dashboard or summarization. In accordance with exemplary embodiments, the agent journey visualization 300 logically connects events pulled from the agent database and presents these events as a timeline, with the events included being selected touchpoints between an agent and the contact center. In this way, a visual representation of each agent's journey map is depicted in readily graspable way. For example, with the agent journey visualization 300, a supervisor can easily view in one place each of the major events associated with the employment of an agent. As shown, the agent journey visualization 300 may include employment events, such as when the agent was hired, when the agent changed teams, and when the agent received raises and evaluations. Further, the agent journey visualization 300 of the agent journey map may also include detected anomalies, for example, as depicted, an anomaly associate with agent mood may be shown.

The agent journey map for an agent may be updated periodically to capture changing data, for example, new employment data, interaction data, and/or adherence data. Such dynamic and evolving data and other events and behaviors may be captured by an agent journey map in several ways. Agent employment data may not be able to be measured or validated against a target value, as it can be changed via a new salary raise or team change. So, such employment changing data may be connected across the timeline. Agent interaction and adherence data may be able to be measured against a target value, and these inputs can generate new values every shift worked by the agent. The decision as to whether any of the newly recorded data should be considered as an anomaly and/or significant enough for inclusion as an event for an agent journey or journey visualization may be made via the monitoring tool 268 and one or more predetermined thresholds. For example, the monitoring tool 268 may be configured to detect deflections or changes or trends in the data and evaluate the extent or magnitude of the change. Then the decision as to whether the detected change or trend in the interaction and adherence data is considered as anomaly is based on whether an applicable threshold is satisfied. If it is, the anomaly may be included in a visualization and/or made part of an alert to a supervisor.

As stated, the prediction of agent attrition may be done via an attrition model developed via machine learning. The machine learning model may be trained on a dataset of agent journey data. Agent journey data includes a diverse set of data features from the three categories discussed above. The agent journey data of agents with known attrition outcomes provide the training datasets. In this way, datasets of employees who left contact centers bring are used to identify patterns or trends that can be used to forecast the attrition rate of current agents. According to exemplary embodiments, the attrition model of the agent attrition predictor 264 is configured as a gradient boost decision tree regression-based algorithm. Such a gradient boost algorithm effectively applies multiple layers of regression over each layer's output value, which can result in more accurate prediction of the output target. As will be appreciated, this algorithm provides supervised machine learning that can model the relationship between data features and continuous target output. This model uses a regression task that outputs a quantitative value (for example, the number of years that each agent is predicted to stay employed at a contact center). The input for this model will be the agent journey data and/or agent journey map, which may include a broad set of data types. In certain preferred embodiments, the data types chosen as inputs are those that have shown to highly correlate with the output target value. It has been discovered that the following data types provide such correlation: number of years previous working experience; number of years in the same role; income; number of different companies previously worked for and/or average time agent stayed at previous employers. The output of the attrition model may be an attrition probability, which may be expressed as a number of years the agent is likely to stay employed at a contact center. In studies it has been found that the accuracy of the model in relation to this type of output is approximately +/−4.5 months. In alternative embodiments, other regression-based algorithms may be used that can plot the data features and predict the relation between those features to the target value.

According to exemplary embodiments, the agent attrition module 260 may render attrition predictions (via the agent attrition predictor 264) on selected agents on a predetermined periodic, rotating, or scheduled basis. In such cases, the agent journey map for agents may periodically be updated with more current or new employment data, interaction data, and/or adherence data for each agent. The agent attrition predictor then may make attrition predictions that take into account the new data when such predictions are scheduled or become due.

Alternatively, as illustrated in FIG. 3, the agent attrition module 260 may employ a monitoring tool 268 that monitors for anomalies that then trigger the agent attrition predictor 264 to make an attrition prediction on the agent (i.e., the agent that corresponds to the detected anomaly). In such cases, the monitoring tool 268 monitors the agent journey data for each agent and, specifically, analyzes the incoming data (for example, incoming interaction data and adherence data to the agent journey service 262) to the to identify if an anomaly is evident for any agent based on the exhibited data patterns. If the monitoring tool 268 detects change in performance data that satisfies the conditions for it to be deemed an anomaly, the agent journey service 262 is notified via an alert. The type of anomaly is identified along with the identity of the agent. Upon receiving this alert, an attrition prediction is triggered for the agent attrition predictor 264. The agent attrition predictor 264 then provides the necessary data stored in the agent journey map and/or agent journey data as inputs to the trained attrition model, which then calculates an output or “predicted rate of attrition”, for example, the number of predicted years that the agent will remain with the contact center. Upon receiving the predicted attrition output from the agent attrition predictor 264, the agent journey service 262 may determine if a communication with a supervisor is warranted, for example, if the attrition rate predicted exceeds a threshold indicating a high risk of attrition. If the threshold is exceeded, a communication may be sent to a supervisor informing them of this risk. As part of this communication, the agent journey service 262 may produce an agent journey visualization (such as the example agent journey visualization 300 of FIG. 4) as well as the predicted attritional rate for the agent. Supplied with this communication, the supervisor can quickly review the employment history of the agent and devise a solution that makes it less likely the agent end their employment with the contact center. For example, the supervisor can review the agent's career record (as provided in the agent journey visualization) to make sure that the agent has been treated fairly in past reviews and/or salary raises. The supervisor may see that perhaps training the agent in a new area or moving the agent to a new department might increase the agent's job satisfaction while not increasing costs or only marginally increasing costs to the contact center. In such cases, a supervisor might judge it to be advantageous to make changes in order to keep an agent instead of running the risk of losing the agent in the near future.

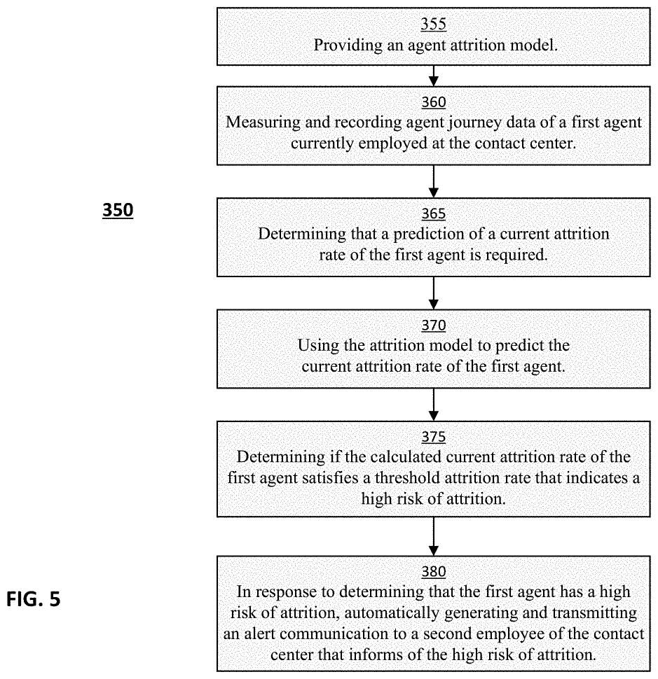

With reference to FIG. 5, a method 350 is provided in accordance with a preferred embodiment. The method 350 relates to predicting an attrition rate for agents employed at a contact center.

At step 355, the method 350 includes the step of providing an attrition model, the attrition model comprising a machine learning model trained pursuant to a training dataset of corresponding inputs and outputs. In certain embodiments, the training of the attrition model comprises learning patterns in the inputs that indicate a value for the output. The inputs of the attrition model may include a plurality of data types including: one or more data types comprising agent employment data; one or more data types comprising agent interaction data; and one or more data types comprising agent adherence data. The output of the attrition model may include an attrition rate for an agent. The training datasets may include the corresponding inputs and outputs associated with respective former agents of the contact center having known attrition outcomes. Further, the attrition rate may be defined as a prediction of how much longer the agent will remain employed at the contact center.

At step 360, the method 350 may include the step of measuring and recording agent journey data of a first agent currently employed at the contact center. In certain embodiments, agent journey data describes aspects related to an employment of the first agent at the contact center and comprises data types that corresponds in kind to the data types of the inputs of the attrition model.

At step 365, the method 350 may include determining that a prediction of a current attrition rate of the first agent is required. As discussed, this determination may be made in different way. In certain embodiments, the step of determining that the prediction of the current attrition rate of the first agent is required may include detecting an occurrence of a triggering event. In certain embodiments, the step of detecting an occurrence of a triggering event may include determining that a predetermined time has been reached at when the predicting of the current attrition rate of the first agent is scheduled. In alternative embodiments, the step of detecting an occurrence of a triggering event may include: monitoring via a monitoring tool the agent journey data of the first agent; from the monitoring, detecting a divergence between a recent trend in more recently measured and recorded values of one or more of the data types of the agent journey data and an established historical trend in less recently measured values of the one or more of the data types of the agent journey data of the first agent; determining that the divergence is of a degree that the divergence satisfies a divergence threshold; and in response to determining that the divergence satisfies the divergence threshold, determining that the divergence comprises an anomaly. In such cases, the determining the divergence constitutes an anomaly is the triggering event.

At step 370, the method 350 may include using the attrition model to predict the current attrition rate of the first agent. This may be done by: providing values for the inputs to the attrition model from applicable current values taken from the corresponding data types of the agent journey data of the first agent; and given the provided inputs, calculating the current attrition rate of the first agent as the output of the attrition model.

At step 375, the method 350 may include determining if the calculated current attrition rate of the first agent satisfies a threshold attrition rate. The satisfying the threshold attrition rate indicates that the first agent has a high risk of attrition.

At step 380, the method 350 may include, in response to determining that the first agent has a high risk of attrition, automatically generating and transmitting an alert communication to a computing device associated with a second employee of the contact center. In certain embodiments, the alert communication informs the second employee that the first agent has the high risk of attrition. In certain embodiments, the second employee is a supervisor of the first agent. In certain embodiments, the alert communication may include an agent journey visualization. The agent journey visualization may be a graphically presented timeline that includes: the milestone dates of the employment of the first agent at the contact center; and an identification of the anomaly and when the anomaly occurred.

Other aspect of the preferred embodiment of the method 350 will now be discussed. for example, in certain embodiments, the agent employment data is defined as data related to milestone dates of an employment of a given agent at the contact center and an history of employment of the given agent before being employed by the contact center. In certain embodiments, the one or more data types of the agent employment data may include: a previous work experience in years; a number of different companies worked at the during a previous work experience in years; an amount of salary raises and bonuses; dates of salary raises and bonuses; a period of time with a current manager; a period of time in a current role; and a period time since a last training session.

In certain embodiments, the agent interaction data is defined as performance data of the given agent related to the given agent handling of interactions with customers. In certain embodiments, the one or more data types of the agent interaction data may include: a number of handled interactions per a given time period; a frequency of first contact resolutions; an amount of customer hold time during interactions; a frequency at which interactions are transferred to another agent; an amount of time required to complete after-interaction work; an amount of silence occurring during interactions; a frequency of talk-over instances in interactions; a rating of customer sentiment during interactions; and customer feedback scores.

In certain embodiments, the agent adherence data is defined as data indicative as to how closely the given agent follows policies of the contact center defining a work schedule for the agents at the contact center. In certain embodiments, the one or more data types of the agent adherence data may include: an extent to which a frequency of breaks taken by the first agent exceeds an allowed frequency of breaks mandated by the contact center; an extent to which a duration of breaks taken by the first agent exceeds an allowed duration of breaks as allowed by a policy of the contact center; an attendance record; an amount of time worked; and an adherence score reflecting a frequency of policy infractions committed related to policies of the contact center.

In exemplary embodiments, the one or more of the data types of the agent journey data may include selected data types that are selected on a basis of building a personality model of the first agent. In such cases, the established historical trend may be a baseline personality model of the first agent, and the recent trend may be a recent divergence in behavior from the baseline personality model. In certain embodiments, the selected data types that are selected to build the personality model of the first agent may include: a first data type in which natural language processing is used to analyze words used by the first agent in transcripts of interactions between the first agent and customers; a second data type in which sound characteristics of recordings of the voice of the first agent during interactions with customers is analyzed for sound characteristics indicative of emotional states; and a third data type relating to a performance characteristic indicative of whether interactions handled by the first agent had a successful resolution. The selected data types that are selected to build the personality model may include data types relating to a mood rating evaluation of the first agent during interactions with customers. The data types relating to the mood rating evaluation may include at least two of the following data types: a positivity score, an empathy score, a patience score, and an attentiveness score.

As one of skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes, and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the present application as defined by the following claims and the equivalents thereof

That which is claimed:

1. A computer-implemented method related to predicting an attrition rate for agents employed at a contact center, the method comprising the steps of:
providing an attrition model, the attrition model comprising a machine learning model trained pursuant to a training dataset of corresponding inputs and outputs, wherein the training of the attrition model comprises learning patterns in the inputs that indicate a value for the output, and wherein:
the inputs comprise a plurality of data types including:
one or more data types comprising agent employment data;
one or more data types comprising agent interaction data; and
one or more data types comprising agent adherence data;
the output comprises an attrition rate for an agent;
measuring and recording agent journey data of a first agent currently employed at the contact center, wherein the agent journey data describes aspects related to an employment of the first agent at the contact center and comprises data types that corresponds in kind to the data types of the inputs of the attrition model;
determining that a prediction of a current attrition rate of the first agent is required;
using the attrition model to predict the current attrition rate of the first agent by:
providing values for the inputs to the attrition model from applicable current values taken from the corresponding data types of the agent journey data of the first agent; and
given the provided inputs, calculating the current attrition rate of the first agent as the output of the attrition model;
determining if the calculated current attrition rate of the first agent satisfies a threshold attrition rate, wherein satisfying the threshold attrition rate indicates that the first agent has a high risk of attrition; and
in response to determining that the first agent has a high risk of attrition, automatically generating and transmitting an alert communication to a computing device associated with a second employee of the contact center, wherein the alert communication informs the second employee that the first agent has the high risk of attrition.

2. The method according to claim 1, wherein:
the agent employment data is defined as data related to milestone dates of an employment of a given agent at the contact center and an history of employment of the given agent before being employed by the contact center;
the agent interaction data is defined as performance data of the given agent related to the given agent handling of interactions with customers; and
the agent adherence data is defined as data indicative as to how closely the given agent follows policies of the contact center defining a work schedule for the agents at the contact center.

3. The method according to claim 2, wherein the current attrition rate comprises a prediction of how much longer the first agent will remain employed at the contact center.

4. The method according to claim 3, wherein the step of determining that the prediction of the current attrition rate of the first agent is required comprises:
detecting an occurrence of a triggering event.

5. The method according to claim 4, wherein the detecting the occurrence of the triggering event comprises:
determining that a predetermined time has been reached at when a predicting of the current attrition rate of the first agent is scheduled.

6. The method according to claim 4, wherein the detecting the occurrence of the triggering event comprises:
monitoring via a monitoring tool the agent journey data of the first agent;
from the monitoring, detecting a divergence between a recent trend in more recently measured and recorded values of one or more of the data types of the agent journey data and an established historical trend in less recently measured values of the one or more of the data types of the agent journey data of the first agent;
determining that the divergence is of a degree that the divergence satisfies a divergence threshold; and
in response to determining that the divergence satisfies the divergence threshold, determining that the divergence comprises an anomaly; and
wherein the determining the divergence as the anomaly comprises the triggering event.

7. The method according to claim 6, wherein the one or more of the data types of the agent journey data comprise selected data types that are selected on a basis of building a personality model of the first agent.

8. The method according to claim 7, wherein the established historical trend comprises a baseline personality model of the first agent and the recent trend comprises a recent divergence in behavior from the baseline personality model.

9. The method according to claim 8, wherein the selected data types that are selected to build the personality model of the first agent comprise:
a first data type in which natural language processing is used to analyze words used by the first agent in transcripts of interactions between the first agent and customers;
a second data type in which sound characteristics of recordings of the voice of the first agent during interactions with customers is analyzed for sound characteristics indicative of emotional states; and
a third data type relating to a performance characteristic indicative of whether interactions handled by the first agent had a successful resolution.

10. The method according to claim 8, wherein the selected data types that are selected to build the personality model include data types relating to a mood rating evaluation of the first agent during interactions with customers; and
wherein the data types relating to the mood rating evaluation comprise at least two of the following data types: a positivity score, an empathy score, a patience score, and an attentiveness score.

11. The method according to claim 6, wherein:
the one or more data types of the agent employment data comprises at least three of the following data types: a previous work experience in years; a number of different companies worked at the during a previous work experience in years; an amount of salary raises and bonuses; dates of salary raises and bonuses; a period of time with a current manager; a period of time in a current role; and a period time since a last training session;
the one or more data types of the agent interaction data comprise at least three of the following data types: a number of handled interactions per a given time period; a frequency of first contact resolutions; an amount of customer hold time during interactions; a frequency at which interactions are transferred to another agent; an amount of time required to complete after-interaction work; an amount of silence occurring during interactions; a frequency of talk-over instances in interactions; a rating of customer sentiment during interactions; and customer feedback scores; and
the one or more data types of the agent adherence data comprise at least two of the following data types: an extent to which a frequency of breaks taken by the first agent exceeds an allowed frequency of breaks mandated by the contact center; an extent to which a duration of breaks taken by the first agent exceeds an allowed duration of breaks as allowed by a policy of the contact center; an attendance record; an amount of time worked; and an adherence score reflecting a frequency of policy infractions committed related to policies of the contact center.

12. The method according to claim 11, wherein the training datasets comprise the corresponding inputs and outputs associated with respective former agents of the contact center having known attrition outcomes.

13. The method according to claim 11, wherein the alert communication comprises an agent journey visualization;
wherein the agent journey visualization comprises a graphically presented timeline that includes:
the milestone dates of the employment of the first agent at the contact center; and
an identification of the anomaly and when the anomaly occurred;
wherein the second employee comprises a supervisor of the first agent.

14. A system related to predicting an attrition rate for agents employed at a contact center, the system comprising:
a processor; and
a memory, wherein the memory stores instructions that, when executed by the processor, cause the processor to perform the steps of:
providing an attrition model, the attrition model comprising a machine learning model trained pursuant to a training dataset of corresponding inputs and outputs, wherein the training of the attrition model comprises learning patterns in the inputs that indicate a value for the output, and wherein:
the inputs comprise a plurality of data types including:
one or more data types comprising agent employment data;
one or more data types comprising agent interaction data; and
one or more data types comprising agent adherence data;
the output comprises an attrition rate for an agent;
measuring and recording agent journey data of a first agent currently employed at the contact center, wherein the agent journey data describes aspects related to an employment of the first agent at the contact center and comprises data types that corresponds in kind to the data types of the inputs of the attrition model;
determining that a prediction of a current attrition rate of the first agent is required;
using the attrition model to predict the current attrition rate of the first agent by:
providing values for the inputs to the attrition model from applicable current values taken from the corresponding data types of the agent journey data of the first agent; and
given the provided inputs, calculating the current attrition rate of the first agent as the output of the attrition model;
determining if the calculated current attrition rate of the first agent satisfies a threshold attrition rate, wherein satisfying the threshold attrition rate indicates that the first agent has a high risk of attrition; and
in response to determining that the first agent has a high risk of attrition, automatically generating and transmitting an alert communication to a computing device associated with a second employee of the contact center, wherein the alert communication informs the second employee that the first agent has the high risk of attrition.

15. The system according to claim 14, wherein:
the agent employment data is defined as data related to milestone dates of an employment of a given agent at the contact center and an history of employment of the given agent before being employed by the contact center;
the agent interaction data is defined as performance data of the given agent related to the given agent handling of interactions with customers; and
the agent adherence data is defined as data indicative as to how closely the given agent follows policies of the contact center defining a work schedule for the agents at the contact center;
wherein the current attrition rate comprises a prediction of how much longer the first agent will remain employed at the contact center.

16. The system according to claim 15, wherein the step of determining that the prediction of the current attrition rate of the first agent is required comprises:
detecting an occurrence of a triggering event.

17. The system according to claim 16, wherein the detecting the occurrence of the triggering event comprises:
monitoring via a monitoring tool the agent journey data of the first agent;
from the monitoring, detecting a divergence between a recent trend in more recently measured and recorded values of one or more of the data types of the agent journey data and an established historical trend in less recently measured values of the one or more of the data types of the agent journey data of the first agent;
determining that the divergence is of a degree that the divergence satisfies a divergence threshold; and
in response to determining that the divergence satisfies the divergence threshold, determining that the divergence comprises an anomaly; and
wherein the determining the divergence as the anomaly comprises the triggering event.

18. The system according to claim 17, wherein the one or more of the data types of the agent journey data comprise selected data types that are selected on a basis of building a personality model of the first agent; and
wherein the selected data types that are selected to build the personality model of the first agent comprise:
a first data type in which natural language processing is used to analyze words used by the first agent in transcripts of interactions between the first agent and customers;
a second data type in which sound characteristics of recordings of the voice of the first agent during interactions with customers is analyzed for sound characteristics indicative of emotional states; and
a third data type relating to a performance characteristic indicative of whether interactions handled by the first agent had a successful resolution.

19. The system according to claim 17, wherein:
the one or more data types of the agent employment data comprises at least three of the following data types: a previous work experience in years; a number of different companies worked at the during a previous work experience in years; an amount of salary raises and bonuses; dates of salary raises and bonuses; a period of time with a current manager; a period of time in a current role; and a period time since a last training session;
the one or more data types of the agent interaction data comprise at least three of the following data types: a number of handled interactions per a given time period; a frequency of first contact resolutions; an amount of customer hold time during interactions; a frequency at which interactions are transferred to another agent; an amount of time required to complete after-interaction work; an amount of silence occurring during interactions; a frequency of talk-over instances in interactions; a rating of customer sentiment during interactions; and customer feedback scores; and
the one or more data types of the agent adherence data comprise at least two of the following data types: an extent to which a frequency of breaks taken by the first agent exceeds an allowed frequency of breaks mandated by the contact center; an extent to which a duration of breaks taken by the first agent exceeds an allowed duration of breaks as allowed by a policy of the contact center; an attendance record; an amount of time worked; and an adherence score reflecting a frequency of policy infractions committed related to policies of the contact center.

20. The system according to claim 17, wherein the alert communication comprises an agent journey visualization; and
wherein the agent journey visualization comprises a graphically presented timeline that includes:
the milestone dates of the employment of the first agent at the contact center; and
an identification of the anomaly and when the anomaly occurred.
